(19) United States
(12) Patent Application Publication
(10) Pub. No.: US 2011/0259050 A1
(43) Pub. Date: Oct. 27, 2011

(54) DECORATIVE FINGER ADORNMENT AND METHOD OF MAKING SAME

(76) Inventor: Krista L. Weber, Hollywood, FL (US)

(21) Appl. No.: 13/093,258

(22) Filed: Apr. 25, 2011

Related U.S. Application Data
(60) Provisional application No. 61/343,183, filed on Apr. 26, 2010.

(51) Int. Cl. A44C 9/00; B32B 38/00; B32B 37/12; B32B 37/14; B32B 37/02; B32B 37/06

(52) U.S. Cl. 63/15; 156/217

(57) ABSTRACT

A ring comprising a first fabric layer; a second fabric layer circumscribing the first fabric layer and a rigid member disposed between the first fabric layer and the second fabric layer. The ring being manufactured by providing a sheet of fabric, folding a first panel about a fold line towards a center of the sheet and folding a second panel along a second fold line towards the sheet such that the first panel and second panel are in abutting relationship once folded to create a seam. A rigid member is placed along the seam. The panel is folded about the seam so as to sandwich the rigid member between the first panel and second panel. Heat is applied to the entire structure to bond the first panel to the second panel. A first end of the panel is affixed to a second end of the panel to form a ring. The ring is placed about a hot cylindrical surface and then removed to harden.

### CROSS-REFERENCE TO RELATED APPLICATION

This application claims priority to U.S. Provisional patent Application No. 61/343,183 filed Apr. 26, 2010, in the entirety hereby incorporated by reference.

### BACKGROUND OF THE INVENTION

The present invention relates to decorative ring-like structures, and more particularly, to a method of fabricating decorative non-metallic ring-like structures using various materials which materials give the ring-like structure fixed shape, durability, and flexibility.

While most people enjoy wearing rings either for style or to commemorate an accomplishment, many people are allergic to metals commonly used in jewelry and are thus unable to wear metal jewelry. There are but a few alternatives presently available to such people such as leather bands which are heavy, stiff and often require metal riveting which does not avoid the allergy. It is also known to use rubber or string, but these rings are thin and do not provide sufficient variety in patterns and are often monochromatic. Decorative fabric ring-like structures are also known, however, such decorative fabric rings typically lack structure and form, easily become frayed, and do not maintain shape and consistency. This invention solves all of these problems by providing an internal structural support, durability, flexibility, and comfort to the wearer of the fabric ring made by the process described herein.

Accordingly, a ring structure which overcomes the shortcomings of the art is desired.

### SUMMARY OF THE INVENTION

The objectives of the present invention are achieved by providing a ring-like decorative ornament that is intended to be worn on the human finger. The ring structure includes a first fabric layer circumscribing an opening. A second fabric layer is disposed upon and circumscribes the first fabric layer. A third fabric layer circumscribes the second layer. A rigid layer is disposed between the second layer and third layer and has a rigidity which is greater than the second fabric layer and third fabric layer. The rigid layer is a heat activated layer in which the rigidity of the rigid layer decreases and the viscosity of the rigid layer decreases upon the application of heat. A fourth fabric layer is disposed upon and circumscribes the third fabric layer.

The decorative ring-like ornament is comprised of a strip of material, preferably fabric, which is folded in a particular manner. A strip of fabric is cut to a particular length and width. The outer edges of the strip are then folded inward toward a middle axis of the fabric strip so as to be in an abutting relationship. The folded edges are then pressed with heat so that this intermediate structure maintains its shape and form. A rigid strip of heat activated adhesive, in one embodiment, is then placed along the middle axis of the folded fabric strip so that it is substantially equal distance from either edge of the folded fabric. The folded fabric is then folded again along the axial length so that the outer edges of the intermediate structure become aligned and the rigid material is positioned along the axial length of the folded fabric. A heating element is then applied to the folded fabric compressing the longitudinal edges of the folded fabric causing them to bond with each other by way of the heat activated adhesive material placed inside, creating a single compressed fabric strip.

The structure of the compressed fabric strip is then folded so that the opposing ends of the strip are adjoined with one another to form a ring. The fabric ring is then heated with a cylindrical iron which reheats the rigid member causing the fabric ring to take on the fixed shape of a ring and eliminating any creases or folds in the fabric. The fabric ring then undergoes a cooling period allowing the rigid material to harden and provide the fabric ring with fixed shape, durability and flexibility.

### BRIEF DESCRIPTION OF THE DRAWING

The invention may take physical form in certain parts and arrangements of parts, a preferred embodiment of which will be described in detail in this specification and illustrated in the accompanying drawings which form a part hereof and wherein:

FIG. 1 is a schematic view of a fabric ring constructed in accordance with of the present invention;

FIG. 2 is a side elevation view of a fabric ring constructed in accordance with the present invention;

FIG. 3 is a bottom plan view of a fabric ring constructed in accordance with the present invention;

FIG. 4 is a cross sectional view taken along line 4-4 of FIG. 2;

FIG. 5 is a top plan view of the fabric during fabrication of the ring in accordance with a first step of the invention; and

FIG. 6 is a top plan view of the fabric during a second step of formation of the ring in accordance with invention.

### DETAILED DESCRIPTION OF THE INVENTION

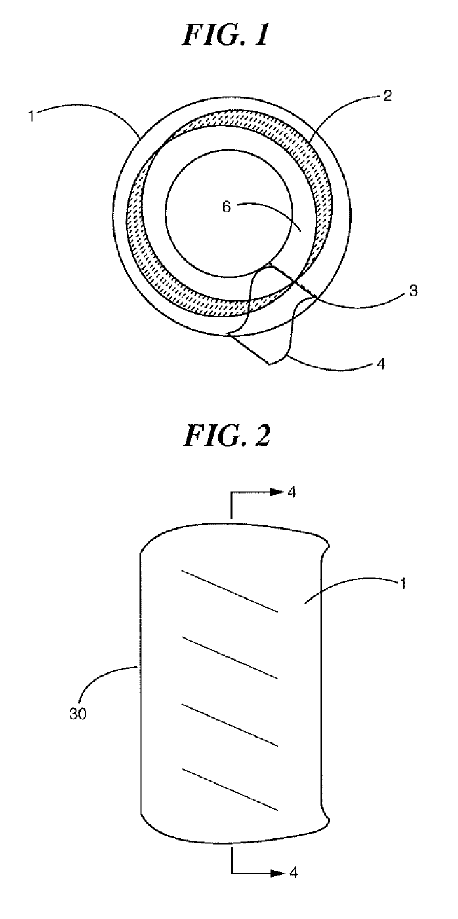

With reference to the drawings, FIG. 1 shows a generally cylindrical decorative fabric ring. Various styles of fabric can be used to create the fabric ring to provide a highly decorative and pleasing appearance.

Referring now to the invention in more detail, FIG. 1 schematically shows a fabric ring constructed in accordance with the present invention and which includes an internal strip of rigid material 2 that is used to provide structure to the ring and bond the folded fabric to create a compressed fabric strip. The shown fabric ring 10 consists of an outer fabric layer 1 and an inner fabric layer 6, which layers make up the outer and inner portion of a compressed fabric strip. Opposite ends of the compressed fabric strip are affixed to each other creating a seam 3. The ends of the fabric strip that create the seam 3 of the compressed fabric strip are in a preferred, nonlimiting embodiment sewn together because this method of attachment results in a more durable fabric ring 10 as opposed to other methods of attachment; however, other fastening means such as velcro, adhesives, staples or the like may be used.

As more clearly seen in FIG. 4, ring 10 includes an inner layer 6 which is made of a first inner layer 6a and a second inner layer 6b. Inner layer 6a, when formed as a ring, defines the opening 12 and second layer 6b circumscribes first layer 6a and is disposed thereon. Rigid member 2 substantially circumscribes fabric layer 6b and is disposed thereon. Outer layer 1 of ring 10 is also formed of two sublayers 1a and 1b. An inner sublayer 1a circumscribes rigid layer 2 while outer layer 1b circumscribes outer layer 1a to provide the ultimate outer surface of ring 10.

Rigid member 2 is a material sufficiently rigid so that at room temperature rigid member 2 maintains the shape of ring 10 by either resisting compression, or if compressed, substantially returning ring 10 to its original shape. In a preferred, but nonlimiting embodiment, rigid material 2 is an adhesive layer, and in a more preferred embodiment, a heat activated or iron on adhesive such as Heat and Bond® iron on adhesive sold by Therm-O-Web. Furthermore, the rigid material 2 has a greater rigidity than either of fabric layers 1 or 6. It is also well within the scope of this invention that the rigid layer be formed of a heat activated adhesive which is at least partially absorbed into at least one of fabric layer 1 or fabric layer 6.

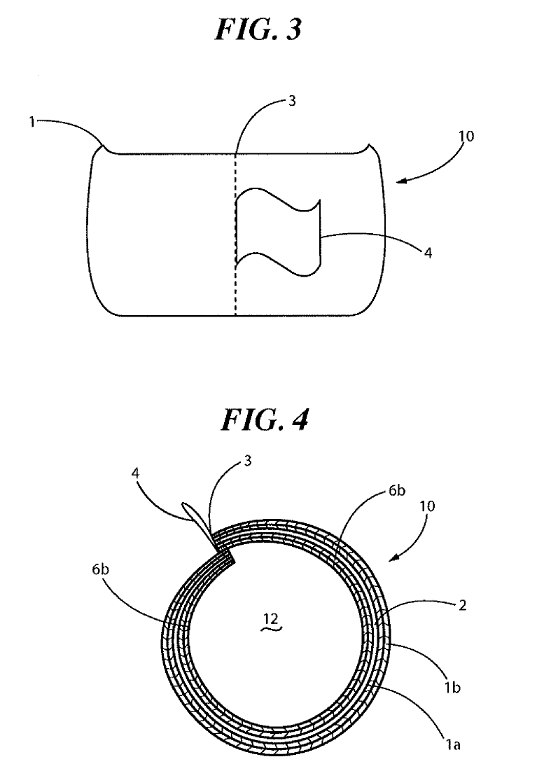

As seen in FIGS. 1 and 3, the ring structure includes a seam 3 from which a hang tag 4 may be affixed. Hang tag 4 as known in the art may be decorative, or may convey information.

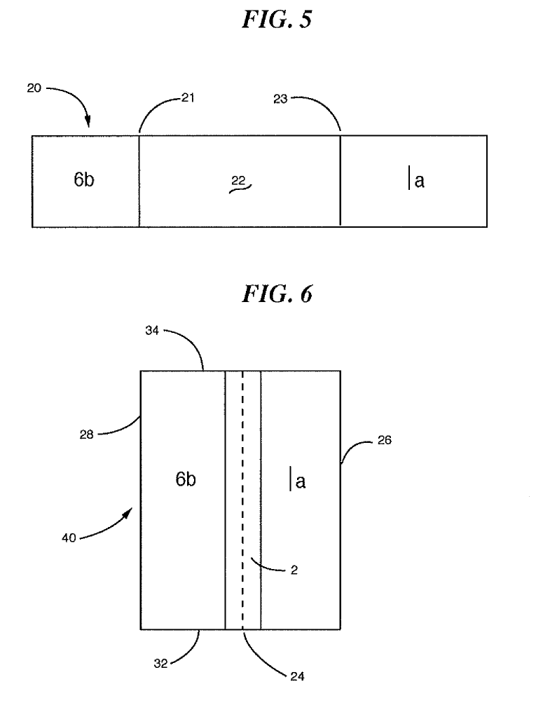

Reference is now made to FIGS. 4-6 in which the method of manufacture of ring 10 is provided. As seen in FIG. 5, a strip of non-rigid, flexible fabric in a preferred, but nonlimiting embodiment, includes a first section 22. Affixed to first section 22 across a fold line 21 is a first layer panel of fabric corresponding to layer 6b. Layer 1a is affixed to panel 22 across a fold line 23. Fabric strip 20 is cut to a particular length and width, in a preferred nonlimiting embodiment, a strip that is approximately 2 inches in width. Panels 1a, 6b are folded about respective fold lines 21, 23 and are dimensioned to substantially be in abutting relationship when folded to create a seam 24 as shown in FIG. 6 to form intermediary strip 40. In a preferred, nonlimiting embodiment during this step, panels which form layers 1a, 6b are folded inward, approximately three-fifths of an inch towards the middle axis 24 of the fabric strip.

The structure is then pressed with heat so as to maintain its shape and form. A strip of rigid material, preferably a heat activated adhesive, such as a polymer resin tackier mixture is placed along a middle axis 24 created at the abutting edges of panels 1a, 6b. In a preferred, nonlimiting embodiment, the rigid material 2 is placed so that it is substantially equal distance from either edge 26, 28 of the folded fabric material.

Panel 6b is folded towards panel 1a with center axis 24 serving as a fold line so that edge 28 is aligned with edge 26 and rigid member 22 is positioned along the axial length of the folded structure. A heating element is then applied to this folded structure to compress the edges 26, 28 and an edge 30 formed at axis 24 once folded (see FIG. 2) causing layer 6b to bond to layer 1a creating a single compressed fabric strip.

If needed, this folded structure of the compressed fabric strip may then be cut into smaller pieces specifically to a size to sufficiently wrap once around the human finger. The compressed fabric strip is then folded so that opposite ends 32, 34 are adjoined with one another. The opposing ends are then attached. In a preferred but nonlimiting embodiment, the ends are sewn together. Label 4 is attached at seam 3 during this step. In a preferred but nonlimiting embodiment, the seam 3 may be formed by an overlapping sandwich construction in which an edge of label 4 is sandwiched between overlapping ends 32, 34 of ring 10. In this embodiment, it is easier to create the overlap on an outer layer so that in a next step, ring 10 is turned inside out so that the overlapping portion of the seam is facing inwardly. In this way, the stitching is concealed on the inside of ring 10.

Fabric ring 10 is then heated with a cylindrical iron which reheats rigid member 2 inside the fabric layers 1, 2 causing fabric ring 10 to take on the fixed shape of a ring and eliminating any creases or folds in the fabric; much like an iron. Fabric 10 is then cooled, approximately 10 minutes in a preferred embodiment, allowing the rigid material to harden and provide the fabric ring 10 with fixed shape, durability and flexibility.

As a result of the folding, the construction panel a is affixed to layer 1b at at least 1a edge. Layer 1b is affixed to layer 6a at at least one edge. Layer 6a is affixed to layer 6b at at least one edge. In this way, the outer edges of ring 10 are formed as a unitary material. In other words, it is a turn of fabric which forms the edges which reduces fraying of the ring while increasing structural integrity as compared to two rings two layers affixed to each other. A purely laminated structure in which each layer is distinct from the other.

Both the inner 1 and outer 2 layers of the fabric ring possess decorative qualities which can be changed to reflect any preference as a function of fabric choice. Also attached to the seam 4 is a tag 5 that is attached to the fabric ring, preferably by means of sewing. The tag may provide further decoration or include indicia such as the fabric ring to determine the fabric content or for other commercially advantageous information.

The advantages of the present invention include, without limitation, that it is able to maintain its shape as a result of the method of construction described herein. It is also durable. It is flexible enough to fit on virtually any finger and is comfortable and light weight. Also, an advantage is that it can be worn by individuals who have allergies to metallic jewelry but whom still wish to adorn their fingers with decorative ornaments.

In a broad embodiment, the present invention is a decorative fabric ring-like structure constructed in such a manner so as to provide fixed shape, durability, and flexibility.

While the foregoing written description of the invention enables one of ordinary skill to make and use what is considered, presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. A ring comprising:
a first fabric layer;
a second fabric layer circumscribing the first fabric layer; and
a rigid member disposed between the first fabric layer and the second fabric layer.

2. The ring of claim 1, wherein the rigid member is a heat activated adhesive.

3. The ring of claim 1, wherein the first layer further comprises a first fabric sublayer and a second fabric sublayer, the first fabric sublayer circumscribing the rigid member, the second sublayer circumscribing the first sublayer.

4. The ring of claim 3, wherein the second layer is comprised of a third sublayer and a fourth sublayer, the rigid member circumscribing and being disposed on the third sublayer, the third sublayer circumscribing and being disposed on the fourth sublayer.

5. The ring of claim 4, wherein the first sublayer and second sublayer are formed as a unitary member.

6. The ring of claim 4, wherein the third sublayer and fourth sublayer are formed as a unitary member.

7. The ring of claim 4, wherein said first sublayer, second sublayer, third sublayer and fourth sublayer are formed as a unitary member.

8. The ring of claim 1, wherein the rigid member is an adhesive partially disposed within at least one of the first fabric layer and second fabric layer.

9. A method for manufacturing a ring comprising the steps of:
providing a sheet of fabric;
folding a first panel about a fold line towards a center of the sheet;
folding a second panel along a second fold line towards the sheet such that the first panel and second panel are in abutting relationship once folded to create a seam;
placing a rigid member, the rigid member becoming less rigid upon the application of heat, along the seam;
folding the panel about the seam so as to sandwich the rigid member between the first panel and second panel;
applying heat to the entire structure to bond the first panel to the second panel;
affixing a first end of the panel to a second end of the panel to form a ring;
placing the ring about a hot cylindrical surface; and
removing the ring from the hot surface to harden the rigid member.

10. The method of claim 9, wherein the rigid member is a heat activated adhesive.

11. The method of claim 9, further comprising the step of sewing the first edge to the second edge.

12. The method of claim 9, wherein the rigid material is substantially centered about the seam.
